(19) United States
(12) Patent Application Publication
(10) Pub. No.: US 2003/0112972 A1
(43) Pub. Date: Jun. 19, 2003

(54) Data carrier for the secure transmission of information and method thereof

(76) Inventors: John B. Hattick, Morgan Hill, CA (US); Matthew Reynolds, Cambridge, MA (US)

Correspondence Address: MOTOROLA, INC., 1303 EAST ALGONQUIN ROAD, IL01/3RD, SCHAUMBURG, IL, 60196

(21) Appl. No.: 10/025,287

(22) Filed: Dec. 18, 2001

(51) Int. Cl. G06F 12/14

(52) U.S. Cl. 380/46; 713/189

(57) ABSTRACT

A data carrier (100) is described for use with a reader for the secure transmission of information. The data carrier (100) comprises an identification number associated with the data carrier (100) and a memory for storing a one-time pad and data. The one-time pad is uniquely associated with the identification number. The data carrier (100) further comprises an encryption circuit for encrypting the data with the one-time pad, and a controller to prevent reuse of bits in the one-time pad. The reader comprises a generator to generate the one-time pad via one of the following: a look-up table, and a pseudorandom number generator operating on a secret key and the identification number of the data carrier.

### FIELD OF THE INVENTION

The present invention relates generally to a data carrier for the secure transmission of information and method thereof.

### BACKGROUND OF THE INVENTION

Portable data carriers have been implemented in a variety of ways, including magnetic stripes found on subway tickets, touch memory, such as those provided by Dallas semiconductor, radio frequency identification (RFID) data carriers, and contacted and contactless smart cards provided by Motorola, Inc. and others. All portable data carriers must interface with a data access device (herein after referred to as the reader) through a communications channel. The communications channel, however, is subject to incidental and/or deliberate eavesdropping. Such eavesdropping can easily be turned to malicious use by creating unauthorized copies of the information, creating counterfeit information and replaying the information among others.

Applications differ in their need for security against copying, counterfeiting or replaying. Some applications (e.g., credit cards, subway tickets, etc.) provide no protection of the actual information or the communications channel in which the information is transmitted. These remote data carriers can easily be copied and reproduced. These applications rely on system level features to detect fraud. In transit applications, magnetic stripe-based portable data carriers are being replaced with contactless smart cards to provide ease of use and reduce fraud. Microprocessors embedded in the card exchange information over an encrypted wireless data link using standard communications protocols, such as ISO 14443. The power demands of the microprocessor to compute the cryptographic transformations and the desire to provide the power wirelessly, however, restrict these cards to short range.

Another form of portable data carriers, the RFID data carrier, is often used in access control systems where they serve as the key to gain access to a controlled space. These data carriers are inexpensive and operate at lower power when compared to microprocessor-based smart cards. The RFID data carrier transmits data to the reader that in turn passes it to the host system for a decision to open the door. The data in this case is often protected by simple cryptographic techniques to obscure the actual data content. This increases the difficulty of creating data carriers with arbitrary content. Protection from eavesdropping is accomplished by the relative short range of the communications channel. However, even data protected by strong cryptographic security can be copied and used in a replay attack to gain unauthorized access if the communications channel is not protected.

The rise of microprocessor-based smart cards has substantially increased the level of security that can be provided in the communications channel. The most capable smart cards implement computationally intense cryptographic algorithms, such as Data Encryption Standard (DES), Triple DES, Elliptic Key, Public Key and soon the Advanced Encryption Standard with large keys. The cryptographic techniques are used in algorithm to mutually authenticate the data carrier and reader to each other and to protect the communication channel from the replay attack. Judicious application of such algorithms within a properly designed system makes the data immune to copying, counterfeiting or replay. The cost of this capability, however, is high and is justified for only a few applications.

Currently available RFID data carriers, such as the Temic E5552 data carrier IC, incorporate password mechanisms to limit write access to the data carrier's EEPROM data memory. However, the data carrier does not encrypt its outgoing data, so an eavesdropper who records data carrier-reader communication or a malicious person who has access to a reader-programmer may easily copy the data carrier and therefore make unauthorized use of its value. Also, such a data carrier IC does not have any simple means to cause its expiry after a specified number of uses.

Currently available inexpensive RFID transponder data carriers do not incorporate cryptographically strong security because of cost and power limitations. For applications, such as remotely-readable electronic ticketing or other applications, which require both security and limited use (i.e., ticket expiry after a certain number of uses or a certain time), currently available data carriers are not suitable because they may be easily copied by someone who eavesdrops on data carrier-reader communication or who has access to a widely-available data carrier reader/programmer unit.

Inexpensive data carriers typically embody low computational functionality. It is difficult to include strong cryptographic security and maintain operating range, as it is computationally intense and thus require substantial power. With the incorporation of portable data carriers into ticketing applications or the like, the need for low cost, provable secure cryptographic protection of remote data is evident.

### BRIEF DESCRIPTION OF THE FIGURES

A preferred embodiment of the invention is now described, by way of example only, with reference to the accompanying figures in which:

FIG. 1 illustrates an exemplary block diagram of a remote data carrier in accordance with the preferred embodiment of the present invention;

FIG. 2 illustrates a flowchart depicting a sequence of steps by which the remote data carrier of FIG. 1 is initialized and data is stored in accordance with the preferred embodiment of the present invention;

FIG. 3 illustrates a flowchart depicting an algorithm that can be used by the data carrier and reader to perform mutual authentication and then to securely transmit the data carrier data in accordance with the preferred embodiment of the present invention;

FIG. 4 illustrates a flowchart depicting an algorithm whereby the data carrier authenticates the reader and skips a random number of bits of the one-time pad to prevent a replay attack in accordance with the preferred embodiment of the present invention; and

FIG. 5 illustrates a block diagram of an exemplary system in accordance with the preferred embodiment of the present invention.

### DETAIL DESCRIPTION OF THE PREFERRED EMBODIMENT

The present invention inexpensively incorporates strong cryptographic information protection into simple, inexpensive data carriers. The present invention incorporates a method and apparatus for provably secure communication between a data carrier and reader. Further, the present invention incorporates an automatic expiry feature, which increase the likelihood of secure data transmissions. The present invention provides a novel combination of a onetime pad cryptographic technique, that is both provably secure and easy and inexpensive to implement, and radio frequency identification (RFID) chip technology.

The present invention, in its preferred embodiment, provides the notable benefit that all computationally intensive cryptographic calculations are performed outside of the data carrier and that only the result, the one-time pad, is stored in the data carrier memory.

As shown in the attached block diagrams and flow charts, the present invention makes use of a well-known technology, the one-time-pad cryptosystem, in a method similar to what is called “stream ciphers” in the cryptography literature. In this novel application, the one-time-pad cryptosystem serves to authenticate the data carrier and reader to each other and to encrypt the transmission of the data carrier's content to the reader. The design is simple and is an inexpensive modification to current RFID data carrier designs that makes good use of currently available memory technologies.

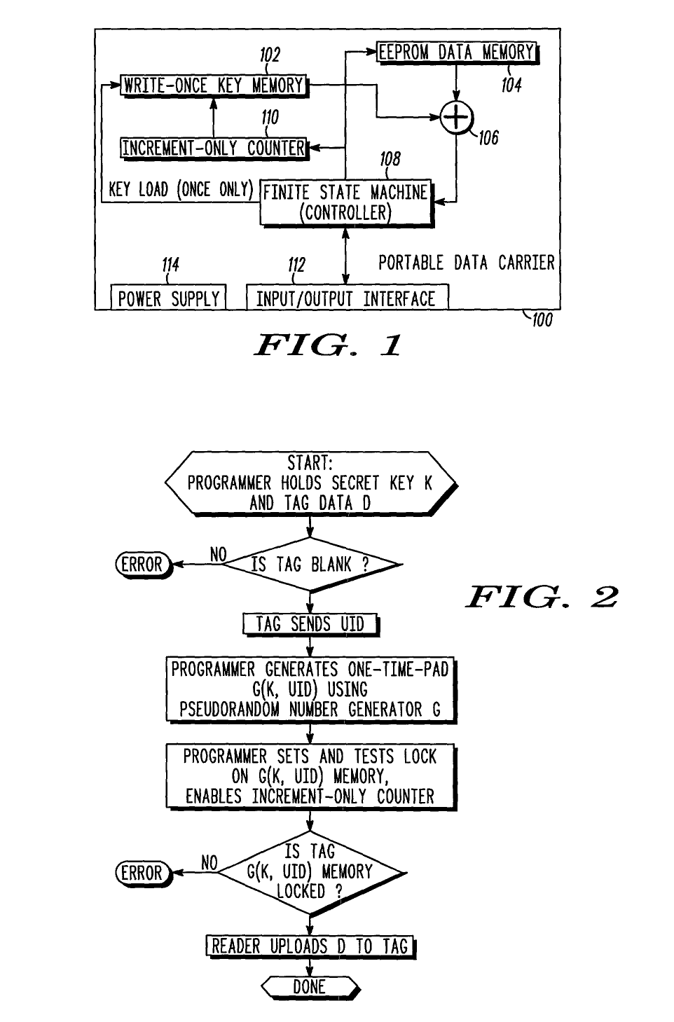

FIG. 1 displays an exemplary block diagram of a portable data carrier 100 implementing the present invention comprising a write-once key memory 102, a data storage memory 104, an exclusive-or (XOR) circuit 106, a controller 108, an increment only counter 110, an input/output interface 112 and a power supply 114.

The write-once key memory 102 stores the one-time pad. The controller 108 can lock this memory so that it cannot be over-written or read out in the clear. The data storage memory 104 contains the application data to be transmitted securely by the remote data carrier 100. The XOR circuit 106 encrypts the data using the one-time pad bit-by-bit by performing the XOR function on the data and the one-time pad key bit streams. The controller 108 controls all aspects of the remote data carrier 100 activity. These activities include loading the one-time pad, locking the key memory, loading the data, authenticating the reader, encrypting the data, incrementing the counter every time a bit of the one-time pad is used and outputting various error codes as required. The counter 110 is incremented by the controller 108 every time a bit of the one-time pad is used in the process and serves as the index of the next bit of the one-time pad to be used; this prevents reuse of bits of the one-time pad that would render the system vulnerable to cryptographic attack. The input/output block 112 provides data communications with the reader or host interface; this interface may be contacted or contactless and includes a transmiter and receiver for bidirectional communications. The input/output block 112 may also provide energy for the power supply derived from the reader or host interface and timing for the controller. The power supply 114 converts the source of energy into a form useful for the data carrier. The reader can supply energy or the data carrier can provide its own source of energy (e.g., a battery, super-capacitor or the like). It is evident to one skilled in the art that the remote data carrier interface can include contact, inductive coupling, capacitive coupling, electromagnetic coupling, optical coupling or any combinations of the foregoing. Further, it is obvious to one skilled in the art that a variety of memory technologies may be applied to store the key and the data.

FIG. 2 illustrates a sequence of steps by which the remote data carrier 100 is initialized and data is stored. It will be appreciated that other sequences can be used to accomplish the same goals. In the preferred embodiment, the data carrier is already programmed with a unique identification number (“UID”) during its manufacture. This code is different for every data carrier. It will be appreciated that the UID can be implemented in a variety of ways. The only requirement is that it is unique for each unit. A secret key (K) is used to generate the one-time pad and the application data (D) is programmed during data carrier initialization. The secret key (K) can be common to a family of data carriers being created for a same purpose, such as tickets to a particular theater or theater company.

In the first step, the programmer interrogates the data carrier to determine whether it is already programmed. If the write once memory is blank and unlocked, the process continues; otherwise, the data carrier generates an error code. The data carrier sends its UID to the programmer. In the preferred embodiment, the programmer generates a one-time pad G(K, UID) using a pseudorandom number generator (G) with the secret key (K) and the UID as seeds. Suitable pseudorandom number generators (G) include symmetric encryption algorithms, such as, DES and asymmetric encryption algorithms, such as RSA or elliptic key. The output of the pseudorandom number generator is a string of random bits g₁, g₂ . . . gₖ of length k (substantially more bits than secret key (K) and UID). A unique one-time pad is thus generated for each data carrier. It will also be appreciated that the initialization process described here must be performed in a secure environment to protect the secret key (K) and prevent an attacker from linking a one-time pad with its corresponding UID.

In the next step, the programmer uploads the one-time pad into memory, verifies success and locks the one-time pad memory. It also _{[atho221]} enables the counter. The data carrier reports success or failure of this operation through an appropriate code. Next, the programmer loads the data onto the data carrier, preferably in plaintext, and verifies success of the operation. This operation need not occur during the initialization process and can be done in a non-secure facility after the data carrier has been initialized with the one-time pad as illustrated in FIG. 2.

Other approaches can be used to achieve the steps outlined in FIG. 2 described above. For example, a true random number generator can be used to create the one-time pad. This, however, increases the system key management issues as each one-time pad and its associated UID must be communicated securely to the application server. In this case, the UID serves as an index into a lookup table to identify the correct one-time pad for the application server to use in the mutual authentication algorithm and data decryption. This alternative, however, further increases the complexity of the application server and communication channels as the one-time pad and its associated UID must be communicated securely from the key server to the application server and then to the reader. The pseudorandom key generation process dramatically reduces the key management burden of the system. The secret key (K) is substantially smaller than the one-time pad; this reduces the number of bits that must be transmitted securely from the one-time pad generation system to the application server and reader. Once the secret key has been transmitted, the application server can upload the secret key (K) securely to the reader that can then interrogate the data carrier, receive the UID in the clear and generate the one-time pad G(K, UID) resident in the data carrier.

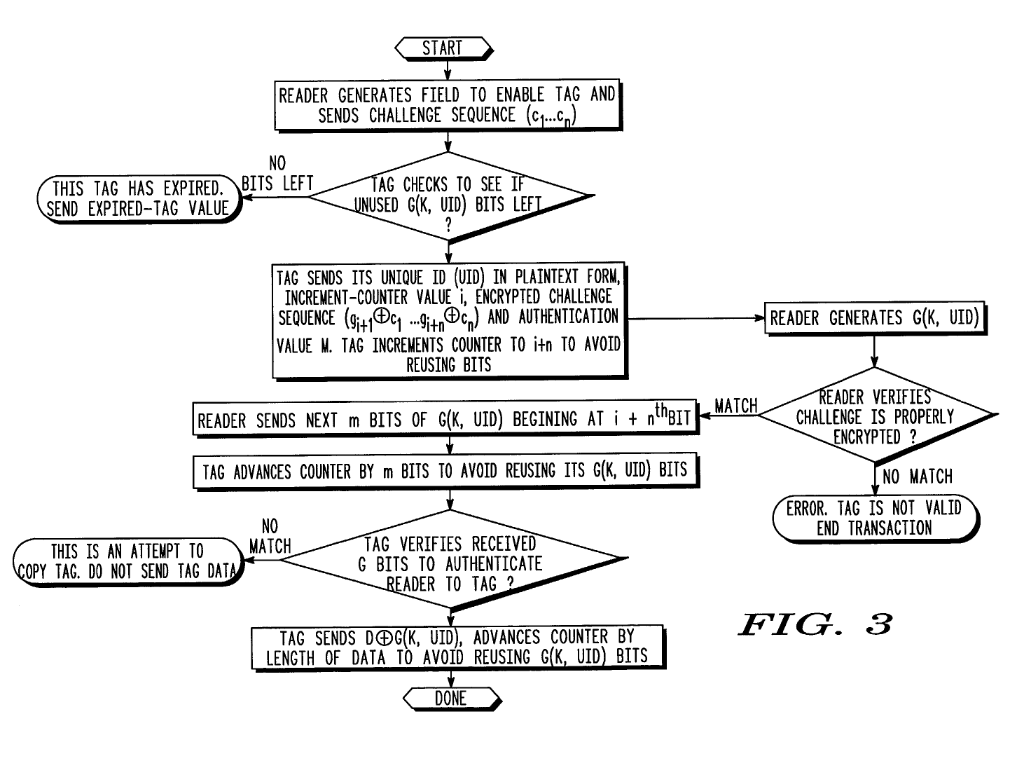

Once the data carrier is initialized and programmed, a mutual authentication algorithm must be performed prior to the transmission of the tag data. FIG. 3 illustrates an algorithm that can be used by the data carrier and reader to perform mutual authentication and then to securely transmit the data carrier data (D). In the first step, the reader generates a field (e.g., electric field, magnetic field, etc.) to power the remote data carrier and sends a challenge sequence (c₁, C₂, . . . , cₙ). The challenge sequence is a random number of random length that changes from transaction to transaction. The data carrier checks to determine whether a sufficient number of bits of G(K, UID) remain to complete a transaction. An error code is sent if insufficient bits remain; otherwise, the data carrier replies with its UID in plaintext, the increment counter value (i) in plaintext, the challenge sequence in cipher text gᵢ₊₁⊕c₁, gᵢ₊₂⊕c₂, . . . , gᵢ₊ₙ⊕cₙ (where ⊕ is the XOR function), and an authentication value (m). The authentication value (m) is a random number that also changes from transaction to transaction. Successful mutual authentication and data encryption/decryption requires generation and synchronization of the one-time pad in the reader. Using the secret key (K) and the UID of the data carrier, the reader generates the unique one-time pad of the data carrier G(K, UID). The reader synchronizes its bit position in the one-time pad with the data carrier by moving to index i, or the i^{th} bit of the onetime pad. The reader decrypts the enciphered challenge sequence and verifies the resulting plaintext matches the challenge sequence thus authenticating the data carrier. If the plaintext does not match the challenge sequence, the data carrier is not valid and the transaction stops. The reader then sends the next m bits of the one-time pad G(K, UID) starting at the i+n^{th} bit in plaintext. Since both the challenge sequence (c) and the authentication number (m) change from transaction to transaction, a replay attack is nearly impossible as it is highly unlikely that an attacker can predict these values in advance. The data carrier verifies that the reader sends the correct m bits of the one-time pad G(K, UID). This validates the reader to the data carrier since only a reader containing the onetime pad and, by extension, sharing the secret key (K) could respond with the proper sequence. It should be noted that throughout the transaction, the data carrier and the reader increments the increment-only counter value (i) and index respectively each time a bit of the one-time pad is used to maintain synchrony in the one time pad. Should the data carrier and reader get out of synch the transaction will fail. After the mutual authentication process, the data carrier sends the data (D) in ciphertext gᵢ₊ₙ₊ₘ₊₁⊕d₁, gᵢ₊ₙ₊ₘ₊₂⊕d₂, . . . etc. and increments the increment-only counter each time a data bit is enciphered. It will be appreciated that an attacker can determine n bits of the one-time pad based on the plaintext and the ciphertext of the challenge sequence. However, because the one-time pad is random and no bits are ever reused, it is highly unlikely that an attacker can predict any future bits of the one-time pad. Further, a sufficiently large key prevents brute force determination of the secret key (K) by aggregating known one-time pad bits from a variety of data carriers and calculating all possible onetime pads using all possible key values.

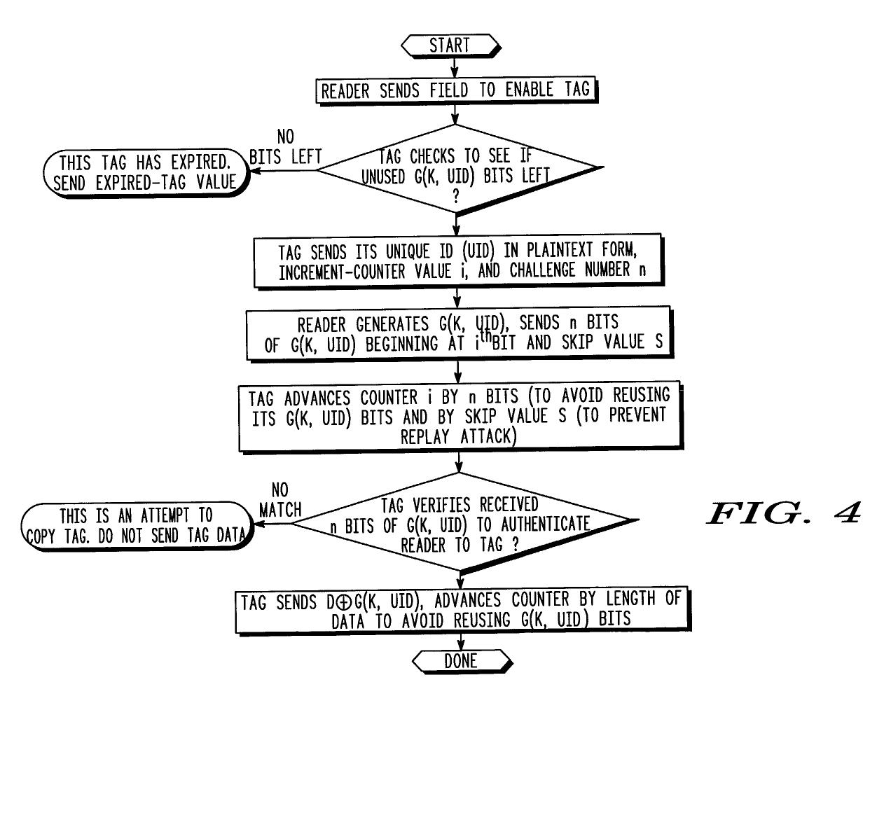

FIG. 4 illustrates another algorithm whereby the data carrier authenticates the reader and skips a random number of bits of the one-time pad to prevent the replay attack. In the algorithm illustrated in FIG. 4, the transaction is initiated when the reader powers the data carrier. The data carrier checks that sufficient bits of the one-time pad remain to complete a transaction. If there are insufficient bits, the data carrier sends an error code; otherwise, the data carrier sends its UID in plaintext, its increment-only counter value i in plaintext, and a challenge number (n). The challenge number (n) is a random number that changes from transaction to transaction. Again, successful authentication and data encryption/decryption requires generation and synchronization of the one-time pad in the reader. The reader generates G(K, UID) and synchronizes its bit position in the one-time pad with the data carrier by moving to index i, or the i^{th} bit of the one-time pad. The reader then sends the next n bits of the one-time pad G(K, UID) starting at the i^{th} bit and the skip value (s). The skip value (s) is also a random number that changes from transaction to transaction and serves the same function as the authentication value m used above. For maximum security, the skip value (s) can be exclusive-or'ed with the one-time pad to obscure its value. The data carrier verifies that the reader sends the correct n bits of the one-time pad G(K, UID). This validates the reader to the data carrier since only a reader containing the one-time pad and, by extension, sharing the secret key (K), could respond with the proper sequence. Throughout the transaction, the data carrier and reader increment the increment only counter value (i) and index each time a bit of the one-time pad is used to maintain synchrony. Should the data carrier and reader get out of synch the transaction will fail. If the sequence is incorrect the data carrier sends an error code and stops responding until a new transaction is initiated; otherwise, the data carrier increments the increment only counter by the skip value (s) and sends the data (D) in ciphertext gᵢ₊ₙ₊ₛ₊₁⊕d₁, gᵢ₊ₙ₊ₛ₊₂⊕d₂, . . . etc. and increments the increment only counter each time a data bit is enciphered. Because the values of the challenge number (n) and skip number (s) are random and change from transaction to transaction, a replay attack is nearly impossible.

It should be noted that other implementations of algorithms using the one-time pad in the authentication process are possible and the above descriptions are exemplary and do not limit the bounds of the present invention.

Each of these algorithms inexorably uses up the bits of the one-time pad. As a result, after a certain number of attempts, no bits will remain and the data carrier will not be able to communicate the data to a reader thus providing the limited expiry feature. Proper design will establish limits on the number of bits used in the one-time pad, challenge sequence, authentication value, challenge number and/or skip value so as to provide the desired level of security against the replay attack and to the number of transactions allowed before expiry of the data carrier.

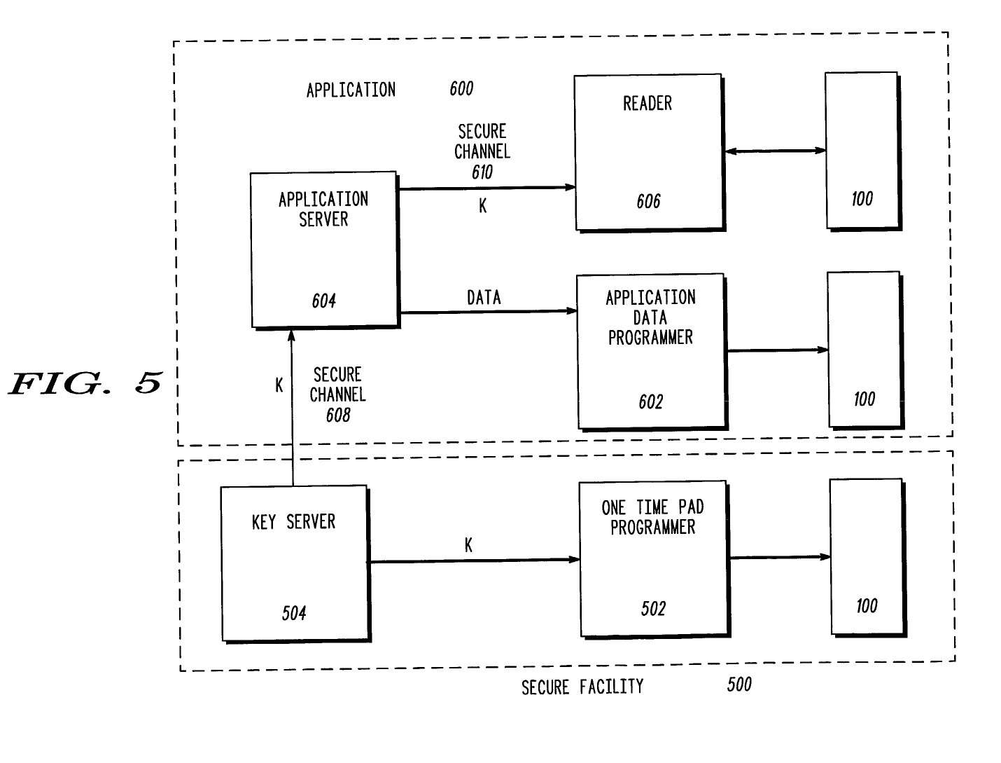

At this point, the design and operation of the data carrier should be clearly understood by those skilled in the art. Let's now turn the discussion to FIG. 5 that illustrates an exemplary system, such as event ticketing, that can be created using this new data carrier concept. A secure facility 500 is provided for the initialization of the data carriers 100. The key server 504 generates and distributes secret keys (K). The secret key (K) is delivered to the programmer 502. The programmer 502 generates the one-time pad G(K, UID) and loads it into the data carrier 100 as previously described. Data carrier 100 has thus been initialized and is provided for use by the application 600. The application 600 includes an application server 604, an application data programmer 602, and a reader 606. It should be noted that a plurality of readers is also possible. The key server 504 transmits the key over a secure channel 608 to the application server 604. Such transmission can be accomplished using a high security cryptographic key exchange algorithm using any of several well-known methods (e.g., the Diffie-Hellman key exchange method). The key is also supplied over a similarly secure channel 610 to the reader 606. The application server 604 provides the application data to the application data programmer 602. The application data is programmed in clear text into the data carrier 100, preferably at the time a ticket is issued. The data carrier 100 can now be presented to the application reader 606. The transactions illustrated in FIGS. 3 and 4 securely transfer the application data to the reader and the reader may grant access without consulting the application server. This system has the advantage that all application data may be programmed in the clear, that a replay attack is nearly impossible, and that the tickets cannot be counterfeited without knowledge of the secret key.

While the invention has been described in conjunction with specific embodiments thereof, additional advantages and modifications will readily occur to those skilled in the art. The present invention, in its broader aspects, is therefore not limited to the specific details, representative apparatus, and illustrative examples shown and described. Various alterations, modifications and variations will be apparent to those skilled in the art in light of the foregoing description. These may include, but certainly not limited to, access control, medical record applications, banking, currency replacement systems, transit or mobility, secure access to the intranet and internet, ad the like. Thus, it should be understood that the invention is not limited by the foregoing description, but embraces all such alterations, modifications and variations in accordance with the spirit and scope of the appended claims.

We claim:

1. A data carrier comprising:
an identification number associated with the data carrier;
a memory for storing a one-time pad and data, wherein the one-time pad is uniquely associated with the identification number;
an encryption circuit, coupled to the memory, for encrypting the data with the one-time pad; and
a controller, coupled to the memory, to prevent reuse of bits in the onetime pad.

2. The data carrier of claim 1 wherein the encryption circuit performs an exclusive-or function.

3. The data carrier of claim 1 further comprising a counter, coupled to the memory, to index to a next bit in the one-time pad.

4. The data carrier of claim 1 further comprising an interface, wherein the interface comprises at least one of the following: capacitive coupling, inductive coupling, electromagnetic coupling, optical coupling, electrical coupling, and contact.

5. The data carrier of claim 1 further comprising a power supply that receives energy from a reader vi a at least one of capacitive coupling, inductive coupling, electromagnetic coupling, optical coupling, and contact.

6. The data carrier of claim 1 further comprising a power supply that receives energy from on of the following: a battery, and a super-capacitor.

7. The data carrier of claim 1 wherein the one-time pad is generated by one of the following: a true random number generator, and a pseudorandom number generator operating on a secret key and the identification number of the data carrier.

8. The data carrier of claim 1 for use with a reader, wherein the reader comprises a generator to generate the one-time pad via one of the following: a look-up table, and a pseudorandom number generator operating on a secret key and the identification number of the data carrier.

9. A data carrier comprising:
a memory storing data and a one-time pad;
an index to synchronize a starting position in the one-time pad;
an identification number uniquely associated with the one-time pad; and
a transmitter to transmit the data to the reader.

10. The data carrier of claim 9 for use with a reader, wherein the reader comprises:
a generator to generate the one-time pad; and
a receiver to receive data from the data carrier.

11. The data carrier of claim 10 wherein the receiver further receives the index from the data carrier to synchronize with the starting position in the one-time pad.

12. The data carrier of claim 10 wherein the data carrier and the reader communicate via one of the following interfaces: capacitive interface, inductive interface, electromagnetic interface, optical interface, electrical interface and contact interface.

13. The data carrier of claim 10 wherein the generator generates the one-time pad by one of the following: a look-up table, and a pseudorandom number generator operating on a secret key and the identification number of the data carrier.

14. The data carrier of claim 9 further comprising a controller to prevent reuse of bits in the one-time pad.

15. The data carrier of claim 9 further comprising a counter to index to a next bit in the one-time pad once a bit has been used.

16. The data carrier of claim 9 wherein the data is stored in a first memory and the one-time pad is stored in a second memory.

17. A method comprising the steps of, at a data carrier:
storing a set of data and a one-time pad, wherein the one-time pad is uniquely associated with an identification number;
synchronizing the one-time pad and an index value with an external device to establish a starting position in the one time pad;
requesting from the external device a number of bits from the one-time pad;
receiving a set of bits and a random skip value from the external device; and
if the set of bits received match the one-time pad, incrementing the index by number of bits requested and the skip value, and encrypting and transmitting at least a portion of the set of data.

18. The method of claim 17 wherein the external device performs the following steps:
generating the one-time pad based on the identification number; and
receiving the index value to synchronize with the starting position in the one-time pad.

19. The method of claim 18 wherein the step of generating comprises encrypting the identification number with a secret key.

20. A method for the secure communication of data between a data carrier and a reader comprising:
associating an identification number with a one time pad;
storing the identification number, one-time pad and data on the data carrier;
setting an index, wherein the index identifies a next available bit of the one-time pad;
transmitting the identification number, the index and a challenge to the reader, wherein the challenge at least requests transmission of bits of the one-time pad;
generating the one-time pad in the reader based on the identification number;
transmitting bits of one-time pad, based on the index and challenge and a random skip value, from the reader to the data carrier; and
verifying, at the data carrier, that the bits transmitted from the reader correspond to the challenge, and if correct, incrementing the index by number of bits in the challenge and the skip value, and encrypting and transmitting at least a portion of the data to the reader.

21. A method for generating a one-time pad comprising the steps of:
providing an identification number;
providing a secret key; and
encrypting the identification number with the secret key.
